(19) United States
(12) Patent Application Publication
(10) Pub. No.: US 2020/0004757 A1
(43) Pub. Date: Jan. 2, 2020

(54) DATABASE MANAGEMENT APPARATUS AND QUERY DIVIDING METHOD

(71) Applicant: KABUSHIKI KAISHA TOSHBA, Minato-ku (JP)

(72) Inventors: Shigeo HIROSE, Kawasaki (JP); Mototaka KANEMATSU, Yokohama (JP)

(73) Assignee: KABUSHIKI KAISHA TOSHBA, Minato-ku (JP)

(21) Appl. No.: 16/411,188

(22) Filed: May 14, 2019

(30) Foreign Application Priority Data
Jul. 2, 2018 (JP) 2018-126130

(51) Int. Cl. G06F 16/27; G06F 16/2458; G06F 16/22; G06F 16/2455

(52) U.S. Cl. CPC G06F 16/27; G06F 16/2455; G06F 16/2246; G06F 16/2471

(57) ABSTRACT

According to one embodiment, a database management apparatus capable of operating as one of a plurality of servers constituting a distributed database in a tree structure includes a processor configured to manage server information of an own server and a subordinate server, analyze an input query, and decide a table used for the query, determine a generation number of query executing modules configured to execute the query, based on the server information of the own server and the subordinate server, and divide the query according to the generation number if a plurality of query executing modules is generated for a subordinate server and accumulate a result of the query executed by the query executing modules of the determined generation number.

### CROSS-REFERENCE TO RELATED APPLICATIONS

This application is based upon and claims the benefit of priority from Japanese Patent Application No. 2018-126130, filed Jul. 2, 2018, the entire contents of which are incorporated herein by reference.

### FIELD

Embodiments described herein relate generally to a database management apparatus and a query dividing method.

### BACKGROUND

In recent years, as network environment improves, for example, the amount of data which companies need to accumulate for operations is rapidly increasing. Hence, for example, a distributed database which can collectively handle data held by each of a plurality of servers is becoming increasingly important.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view for schematically explaining an example of a basic function of a database management apparatus according to an embodiment.

FIG. 2 is a view illustrating an example of a distributed database in a tree structure which can be configured by the database management apparatus according to the embodiment.

FIG. 3 is a view illustrating an example of a hardware configuration of the database management apparatus according to the embodiment.

FIG. 4 is a view illustrating an example of a function block of a DBMS program which operates on the database management apparatus according to the embodiment.

FIG. 5A is a view illustrating an example of processor count information used by the DBMS program which operates on the database management apparatus according to the embodiment.

FIG. 5B is a view illustrating an example of subordinate table record count information used by the DBMS program which operates on the database management apparatus according to the embodiment.

FIG. 5C is a view illustrating an example of a table used by the DBMS program which operates on the database management apparatus according to the embodiment.

FIG. 6 is a view illustrating cooperation between a host server and a subordinate server of the distributed database which is configured by the database management apparatus according to the embodiment.

FIG. 7A is a view for explaining a specific operation example (first case) of the database management apparatus according to the embodiment.

FIG. 7B is a view for explaining the specific operation example (first case) of the database management apparatus according to the embodiment.

FIG. 8A is a view for explaining the specific operation example (first case) of the database management apparatus according to the embodiment.

FIG. 8B is a view for explaining the specific operation example (first case) of the database management apparatus according to the embodiment.

FIG. 8C is a view for explaining the specific operation example (first case) of the database management apparatus according to the embodiment.

FIG. 9A is a view for explaining a specific operation example (second case) of the database management apparatus according to the embodiment.

FIG. 9B is a view for explaining the specific operation example (second case) of the database management apparatus according to the embodiment.

FIG. 10A is a view for explaining the specific operation example (second case) of the database management apparatus according to the embodiment.

FIG. 10B is a view for explaining the specific operation example (second case) of the database management apparatus according to the embodiment.

FIG. 10C is a view for explaining the specific operation example (second case) of the database management apparatus according to the embodiment.

FIG. 11A is a view for explaining a specific operation example (third case) of the database management apparatus according to the embodiment.

FIG. 11B is a view for explaining the specific operation example (third case) of the database management apparatus according to the embodiment.

FIG. 12A is a view for explaining the specific operation example (third case) of the database management apparatus according to the embodiment.

FIG. 12B is a view for explaining the specific operation example (third case) of the database management apparatus according to the embodiment.

FIG. 12C is a view for explaining the specific operation example (third case) of the database management apparatus according to the embodiment.

FIG. 13A is a view for explaining an operation of collectively allocating a plurality of processes to one processor in the database management apparatus according to the embodiment.

FIG. 13B is a view for explaining an example of the operation of collectively allocating the plurality of processes to the processor in the database management apparatus according to the embodiment.

FIG. 14 is a view for explaining an example of a query dividing method of the database management apparatus according to the embodiment.

FIG. 15 is a flowchart illustrating an example of a flow of query acceptance processing executed by the database management apparatus according to the embodiment.

FIG. 16 is a view illustrating a modification of a distributed database in a tree structure which can be configured by the database management apparatus according to the embodiment.

FIG. 17 is a view illustrating a first example of cooperation between servers of different configurations in the distributed database which is configured by the database management apparatus according to the embodiment.

FIG. 18 is a view illustrating a second example of cooperation between servers of different configurations in the distributed database which is configured by the database management apparatus according to the embodiment.

FIG. 19 is a flowchart illustrating an example of a flow of subordinate server information update processing executed by the database management apparatus according to the embodiment.

### DETAILED DESCRIPTION

In general, according to one embodiment, a database management apparatus capable of operating as one of a plurality of servers constituting a distributed database in a tree structure is provided. The database management apparatus includes a processor. The processor is configured to manage server information of an own server and a subordinate server, analyze an input query, and decide a table used for the query, determine a generation number of query executing modules configured to execute the query, based on the server information of the own server and the subordinate server, and divide the query according to the generation number if a plurality of query executing modules is generated for a subordinate server and accumulate a result of the query executed by the query executing modules of the determined generation number.

Various embodiments will be described hereinafter with reference to the accompanying drawings.

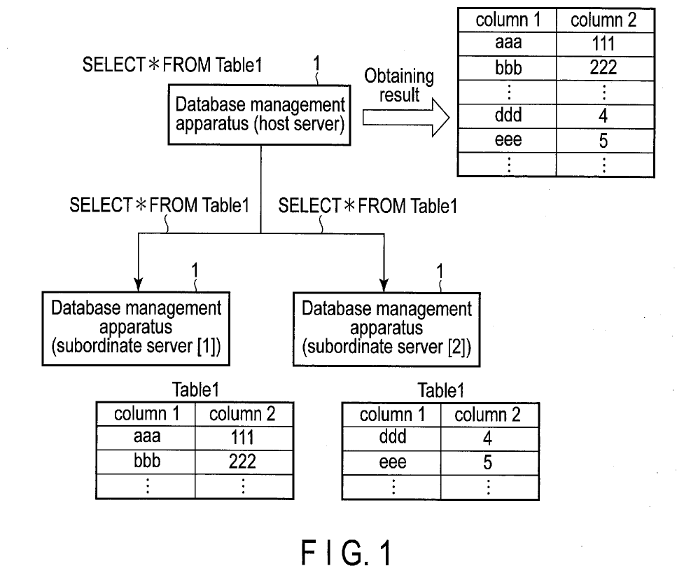

FIG. 1 is a view for schematically explaining a basic function of a database management apparatus 1 according to the embodiment.

As illustrated in FIG. 1, this database management apparatus 1 can operate as a host server which is placed at a higher level of the other database management apparatuses 1, and can operate as a subordinate server which is placed at a lower level of the other database management apparatuses 1. The database management apparatus 1 has an external table function which can handle data of different data sources, and, more specifically, tables held by the subordinate servers as if this database management apparatus 1 held this table. The database management apparatus 1 uses the external table function and can obtain data all at once from a plurality of tables by performing virtual table conversion for virtualizing tables dispersed in a plurality of subordinate servers as one table.

For example, as illustrated in FIG. 1, the database management apparatus 1 which operates as the host server can obtain data of Tables 1 which are tables dispersed in the two other database management apparatuses 1 which operate as the subordinate servers all at once as if the database management apparatus 1 obtained the data from the table held by the database management apparatus 1 by issuing a query “SELECT * FROM Table1”.

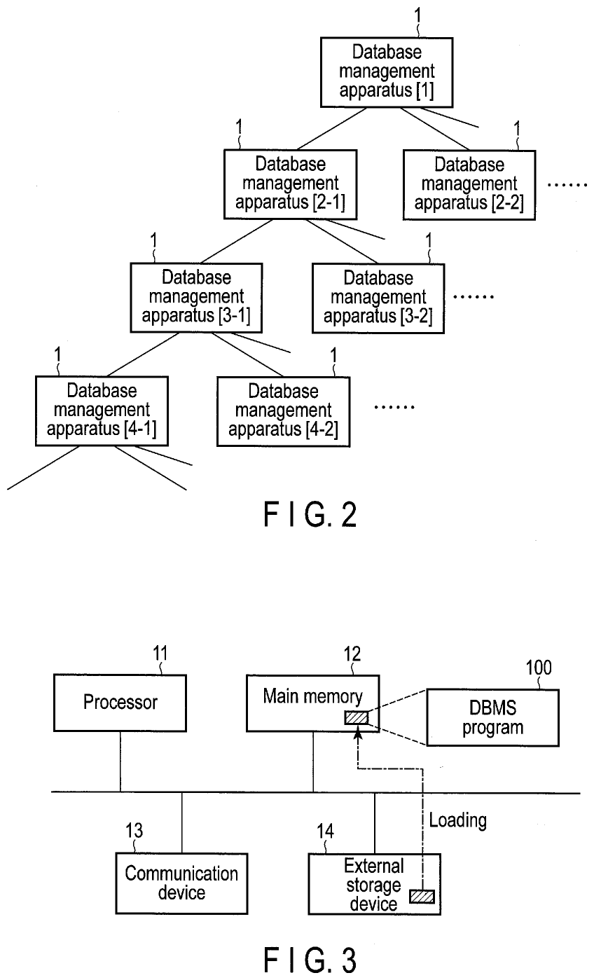

Furthermore, as described above, the database management apparatus 1 can operate as one of the host server and the subordinate server. That the database management apparatus 1 can operate as one of the host server and the subordinate server means not only that the database management apparatus 1 exclusively selectively operates as one of the host server and the subordinate server, but also that the database management apparatus 1 operates as the host server in relation to the another certain database management apparatus 1, and operates as the subordinate server in relation to the another different database management apparatus 1. Hence, by connecting a plurality of database management apparatuses 1 in a tree shape as illustrated in, for example, FIG. 2, it is possible to configure a distributed database in a tree structure. In other words, the database management apparatus 1 can operate as one of a plurality of servers which configures the distributed database in the tree structure. In FIG. 2, for example, a database management apparatus [2-1]1 operates as the subordinate server in relation to a database management apparatus [1]1, and operates as the host server in relation to a database management apparatus [3-1]1 and a database management apparatus [3-2]1. Furthermore, each database management apparatus 1 in FIG. 2 can accept a query from a user, and can obtain a result of this query by using data of a table held by subordinate servers under direct control. In addition, each database management apparatus 1 can also obtain a result of a query accepted from the user by using data of a table held by each database management apparatus 1.

FIG. 3 is a view illustrating an example of a hardware configuration of the database management apparatus 1.

As illustrated in FIG. 3, the database management apparatus 1 includes a processor 11, a main memory (internal storage device) 12, a communication device 13 and an external storage device 14. The database management apparatus 1 may be a general purpose computer. For example, when a DBMS (DataBase Management System) program 100 stored in the external storage device 14 is loaded to the main memory 12, and is executed by the processor 11, the general purpose computer operates as the database management apparatus 1. The communication device 13 controls communication for receiving a query from the user, transmitting a result of this query to the user, receiving a query from the another database management apparatus 1 which is the host server, transmitting the result of this query to this another database management apparatus 1, transmitting the query to the another database management apparatus 1 which is the subordinate server, and receiving a result of this query from the another database management apparatus 1.

In addition, FIG. 3 schematically illustrates the hardware configuration and illustrates each component one by one. However, each component can be provided in a plural number. For example, the database management apparatus 1 generally includes a plurality of mounted processors 11.

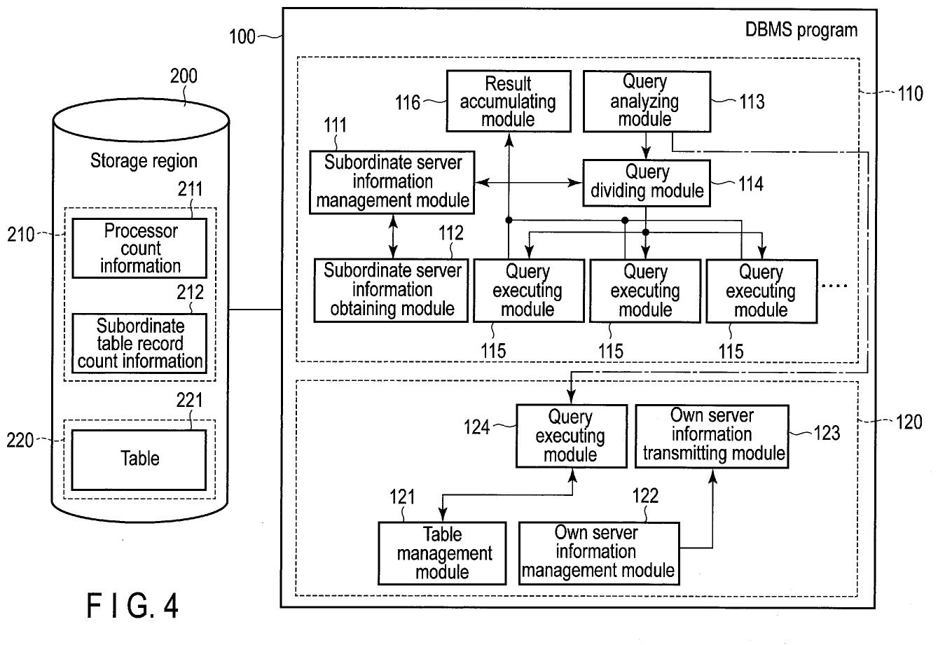

FIG. 4 is a view illustrating an example of a function block of the DBMS program 100. In addition, FIG. 4 illustrates an outline in a storage region 200 secured by the DBMS program 100, too. This storage region 200 is, for example, a region secured on the external storage device 14, and is accessed by the DBMS program 100 and, more specifically, the processor 11 which executes the DBMS program 100 via the main memory 12.

The DBMS program 100 roughly includes a processing module 110 which operates as the host server, and a processing module 120 which operates as a subordinate server. The DBMS program 100 includes a subordinate server information management module 111, a subordinate server information obtaining module 112, a query analyzing module 113, a query dividing module 114, a query executing module 115 and a result accumulating module 116 as components of the former processing module 110. Furthermore, the DBMS program 100 includes a table management module 121, an own server information management module 122, an own server information transmitting module 123 and a query executing module 124 as components of the latter processing module 120. In addition, these components are not necessarily realized as one module of the DBMS program 100, and may be realized as electronic circuits, for example.

Furthermore, information stored in the storage region 200 is also roughly classified into information 210 used for an operation of the host server, and information 220 used for an operation of the subordinate server. Elements of the former information 210 include processor count information 211 and subordinate table record count information 212, and elements of the latter information 220 include a table 221.

The subordinate server information management module 111 stores and manages subordinate server information obtained by the subordinate server information obtaining module 112 as the processor count information 211 and the subordinate table record count information 212 described below in the storage region 200. The subordinate server information obtaining module 112 receives subordinate server information transmitted from the subordinate server to transfer to the subordinate server information management module 111. This subordinate server information corresponds to own server information transmitted by the own server information transmitting module 123 on the subordinate server side to the host server.

The query analyzing module 113 analyzes a query accepted from the user, and decides a table related to this query and, more specifically, decides which table this query uses. The query dividing module 114 firstly determines the generation number of the query executing modules 115 which execute this query based on the processor count information 211 and the subordinate table record count information 212 managed by the subordinate server information management module 111 in response to a decision result of the query analyzing module 113, and generates the determined generation number of the query executing modules 115. The generation number of the query executing modules 115 corresponds to a parallel number for executing a query in parallel. Furthermore, the query dividing module 114 secondly divides a query according to the generation number when, for example, a plurality of query executing modules 115 is generated for one subordinate server. This query dividing module 114 works to allow this database management apparatus 1 to efficiently allocate limited resources, which will be described below.

The query executing module 115 is dynamically generated by the query dividing module 114, and executes a query passed by the query dividing module 114. More specifically, the query executing module 115 transmits a query passed from the query dividing module 114 to the subordinate server to which this database management apparatus 1 is allocated, and transfers a result of the query received from the subordinate server to the result accumulating module 116.

The result accumulating module 116 accumulates results of queries accepted from the query executing module 115, and transfers the result of the queries to the user who is an issuance source of this query.

The table management module 121 manages the table 221. The table 221 is a data structure of a table format including rows (records) and columns, and a plurality of tables 221 can be held.

The own server information management module 122 manages the number of processors of the database management apparatus 1 and the number of holding records of the table 221 as own server information. In addition, the number of processors of the database management apparatus 1 is stored as the processor count information 211 in the storage region 200. The own server information transmitting module 123 transmits the own server information managed by the own server information management module 122 to the host server. This own server information corresponds to subordinate server information obtained by the subordinate server information obtaining module 112 on the host server side. The own server information is transmitted from the own server information transmitting module 123 to the host server when, for example, the number of holding records of the table 221 is updated.

The query executing module 124 obtains data from the table held by the own server based on the query transmitted from the host server, more specifically, the query executing module 115 on the host server side, and transfers the obtained data to the query executing module 115 of the host server. While the query executing modules 115 are dynamically generated by the query dividing module 114, a number of query executing modules 124 corresponding to the number of processors of the database management apparatus 1 are statically generated. Furthermore, every time a query from the host server is received, the query executing module 124 may be dynamically generated.

In addition, when an analysis result of a query accepted from the user in the query analyzing module 113 shows that this query does not use the tables dispersed in a plurality of subordinate servers, but uses the table held by the own server, this query is transferred from the query analyzing module 113 to the query executing module 124. When receiving the query from the query analyzing module 113, the query executing module 124 transfers a result of the query to the user who is an issuance source of this query. In this case, too, the query dividing module 114 may divide the query according to, for example, the number of the query executing modules 124 which is the same as the number of processors of the own server, and transfer the divided queries to the query executing modules 124.

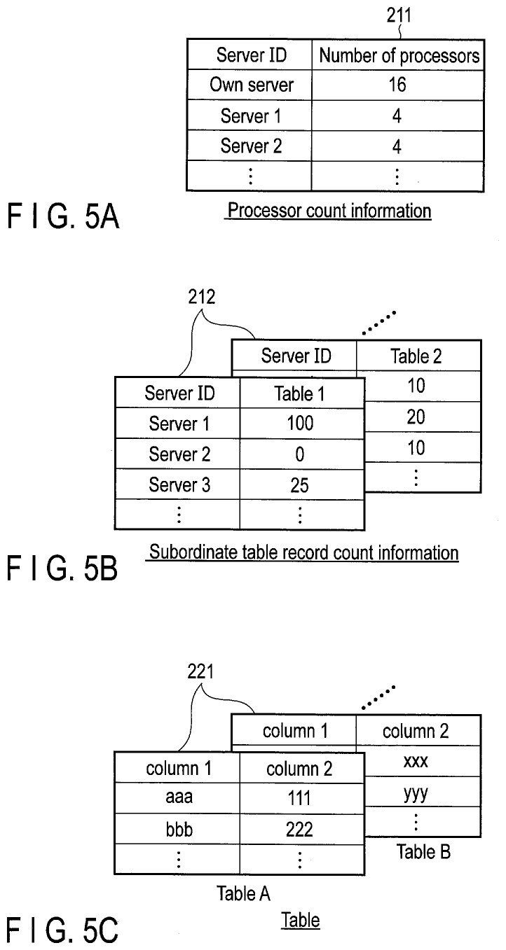

FIGS. 5A to 5C are views illustrating an example of the processor count information 211, the subordinate table record count information 212, and the table 221 stored in the storage region 200 secured by the DBMS program 100.

As illustrated in FIG. 5A, the processor count information 211 includes the number of processors of the own server, i.e., the database management apparatus 1, and the numbers of processors of subordinate servers (a server 1, a server 2 and . . . ). This example shows that the database management apparatus 1 includes 16 processors, and the server 1 and the server 2 include the four processors.

As illustrated in FIG. 5B, the subordinate table record count information 212 includes the number of holding records of each subordinate server in the tables dispersed in a plurality of subordinate servers. This example shows that the number of a table 1 is 100 records held in the server 1, the number of the table 1 is 0 record held in the server 2 and the number of the table 1 is 25 records held in the server 3.

As illustrated in FIG. 5C, the table 221 is a table held by the own server, i.e., the database management apparatus 1. This example shows that a table A and a table B are held.

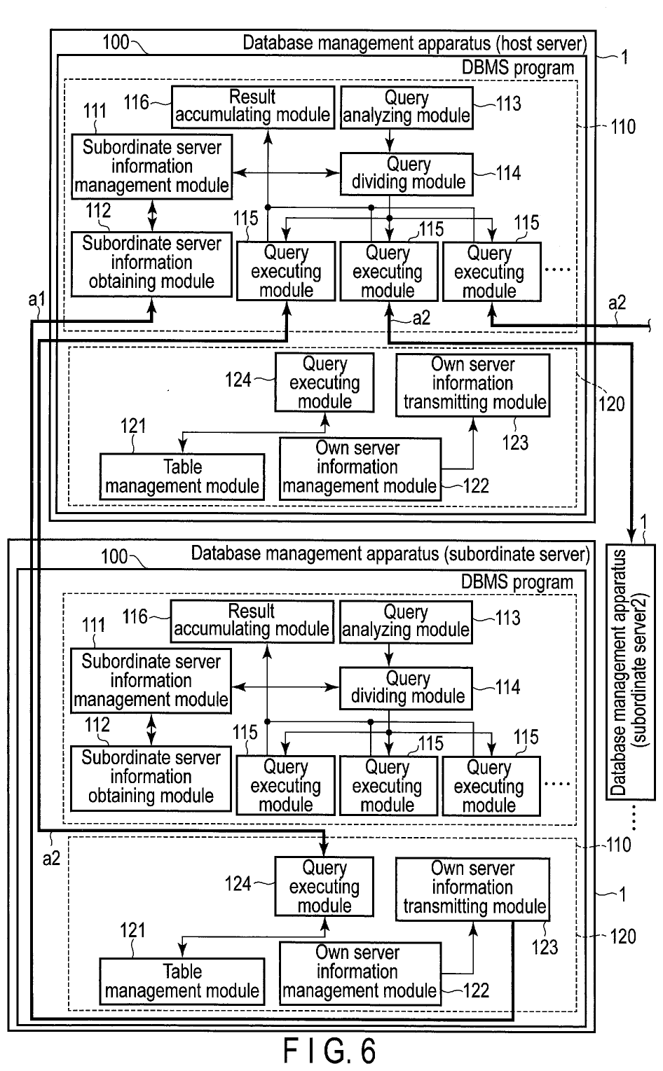

FIG. 6 is a view illustrating cooperation between the database management apparatus 1 which operates as the host server, and the database management apparatus 1 which operates as the subordinate server.

As described above, the host server and the subordinate server first cooperate in such a way that the own server information transmitting module 123 on the subordinate server side transfers own server information to the subordinate server information obtaining module 112 on the host server side (FIG. 6: a1). Furthermore, the host server and the subordinate server cooperate in such a way that the query executing module 115 on the host server side transmits a query to the query executing module 124 on the subordinate server side, and the query executing module 124 on the subordinate server side transmits a result of the query to the query executing module 115 on the host server side (FIG. 6: a2).

In this regard, for deeper understanding of the database management apparatus 1 according to the present embodiment, a typical method for executing a query which uses tables dispersed in a plurality of subordinate servers will be described as one comparative example.

When, for example, the tables used by this query are dispersed and held by the three subordinate tables, three processes (corresponding to the query executing modules 115 of the database management apparatus 1 according to the present embodiment) which execute this query are generated, and allocated to each subordinate server to make each subordinate server execute the query. However, this method does not take into account the number of holding records in each subordinate server, and therefore resources are hardly allocated efficiently.

By contrast with this, the database management apparatus 1 according to the present embodiment realizes efficient resource allocation by taking into account not only the number of holding records of the table in each subordinate server which holds the table used for a query, but also the number of processors of the own server and the number of processors of each subordinate server. This point will be described in detail below.

First, a basic rule of the database management apparatus 1 according to the present embodiment for executing a query which uses tables dispersed in a plurality of subordinate servers will be described.

Firstly, in this database management apparatus 1, the total generation number (parallel number) of the query executing modules 115 generated by the query dividing module 114 is the number of processors of the own server at maximum. In addition, when, for example, the number of processors of the own server is less than the number of subordinate servers, the total generation number of the query executing modules 115 may exceed the number of processors of the own server.

Secondly, in this database management apparatus 1, the number of the query executing modules 115 generated for each subordinate server is the number of processors of each subordinate server at maximum.

In view of the above basic rule, this database management apparatus 1, more specifically, the query dividing module 114 generates an appropriate number of the query executing modules 115 as follows.

The query dividing module 114 first calculates a ratio E of the number of holding records of each subordinate server in a table used for a query decided by the query analyzing module 113 by using the subordinate table record count information 212 managed by the subordinate server information management module 111. The ratio ε of the number of holding records is calculated as, for example, “ratio εserver 1 of number of holding records of subordinate server 1=number of holding records of subordinate server 1/number of holding records of overall subordinate servers”.

Next, the query dividing module 114 temporarily calculates the number of the query executing modules 115 generated for each subordinate server by using the ratio c of the number of holding records calculated for each subordinate server, and the number of processors N of the own server included in the processor count information 211 managed by the subordinate server information management module 111. The generation number of the query executing modules 115 is calculated, for example, as “generation number of query executing modules 115 for subordinate server 1=number of processors N of own server×ratio εserver 1 of number of holding records of subordinate server 1”. In this regard, the query dividing module 114 determines a calculated value as one when the calculated value is less than one, and converts the calculated value into an integer value by, for example, rounding when the calculated number is one or more and includes a decimal.

Lastly, the query dividing module 114 determines the number of the query executing modules 115 generated for each subordinate server, i.e., the total generation number of the query executing modules 115 by using the temporarily calculated number of the query executing modules 115 generated for each subordinate, the number of processors N of the own server included in the processor count information 211 managed by the subordinate server information management module 111, and the number of processors M of each subordinate server. More specifically, the query dividing module 114 determines the generation number of the query executing modules 115 according to the above-described basic rule of the database management apparatus 1 according to the present embodiment. That is, the query dividing module 114 determines the generation number of the query executing modules 115 such that the total generation number of the query executing modules 115 does not exceed the number of processors of the own server and the number of the query executing modules 115 generated for each subordinate server does not exceed the number of processors of each subordinate server.

Next, a specific operation example where the query dividing module 114 determines the generation number of the query executing modules 115 will be described by citing some model cases.

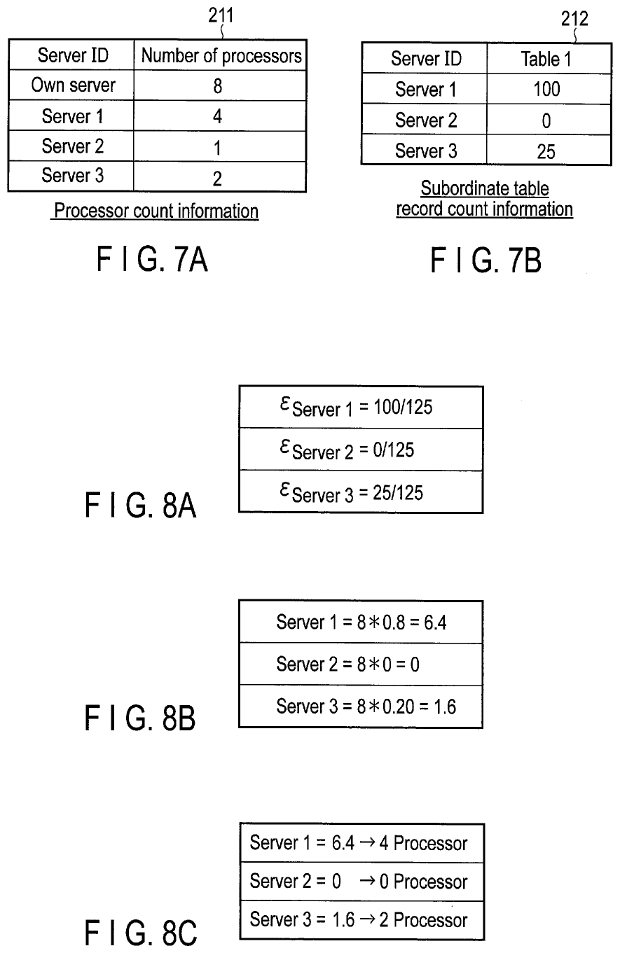

First, the operation example of the query dividing module 114 in a case where the number of processors of the host server (own server) is larger than the number of processors of the subordinate server (which holds a table used for a query) will be described with reference to FIGS. 7A and 7B and 8A to 8C in view of FIG. 6.

Hereinafter, it is assumed that there are subordinate servers 1 to 3, and a query which uses the tables 1 dispersed in these subordinate servers is executed. Furthermore, as illustrated in FIG. 7A, the numbers of processors are assumed to be eight in the own server (host server), four in the server 1, one in the server 2 and two in the server 3. Furthermore, as illustrated in FIG. 7B, the numbers of holding records of the table 1 are assumed to be 100 in the server 1, 0 in the server 2 and 25 in the server 3. That is, the number of holding records of the overall subordinate servers is 125.

As illustrated in FIG. 8A, the query dividing module 114 first calculates the ratio ε of the numbers of holding records of the servers 1 to 3 in the tables 1. When calculating the ratio ε of the number of holding records of each subordinate server, the query dividing module 114 next temporarily calculates the number of the query executing modules 115 generated for each subordinate server as illustrated in FIG. 8B.

At this point of time, the query dividing module 114 calculates 6.4 as the numbers of the query executing module 115 for the server 1, 0 as the numbers of the query executing module 115 for the server 2 and 1.6 as the numbers of the query executing module 115 for the server 3. In this regard, the number of processors of the server 1 is four, and therefore the query dividing module 114 determines four as the number of the query executing modules 115 generated for the server 1 instead of six which is obtained by rounding 6.4. Furthermore, the query dividing module 114 determines 0 as the number of the query executing modules 115 generated for the server 2. Furthermore, the query dividing module 114 determines two (which is within the number of processors of the server 2) which is obtained by rounding 1.6, as the number of the query executing modules 115 generated for the server 3.

That is, as illustrated in FIG. 8C, the query dividing module 114 determines to generate the six query executing modules 115 in total including the four query executing modules 115 for the server 1, the zero query executing module 115 for the server 2 and the two query executing modules 115 for the server 3. Hence, the six processors among the eight processors of the own server are used, and this query is executed in parallel by the six query executing modules 115. Furthermore, the four query executing modules 115 among the six query executing modules 115 are for the server 1, and the two query executing modules 115 are for the server 3. The query dividing module 114 also divides a query according to the generation number of the query executing modules 115 per subordinate server. This query dividing method will be described below. However, simply describing, for example, the server 1 as an example, four queries which target at 25 different records among 100 records are generated. The four divided queries are distributed to the four query executing modules 115 generated for the server 1, and are transferred from each query executing module 115 to the query executing module 124 on the subordinate server side. Each of the six query executing module 115 generated by the query dividing module 114 accepts a query result from the query executing module 124 on the subordinate server side, and transfers the query result to the result accumulating module 116. The query result is accumulated in the result accumulating module 116, and is returned to the user.

Thus, the query dividing module 114 operates to allocate more processors for processing related to a subordinate server having a larger number of holding records (processing amount) and a higher load. Furthermore, allocating the processors of the own server exceeding the number of processors of one subordinate server to processing related to the one subordinate server makes, for example, part of processors standby and is wasteful. Therefore, the query dividing module 114 operates without causing such waste.

That is, compared to a case where a process which executes a query is uniformly generated according to the number of subordinate servers as in the one aforementioned comparative example, the database management apparatus 1 according to the present embodiment realizes efficient resource allocation.

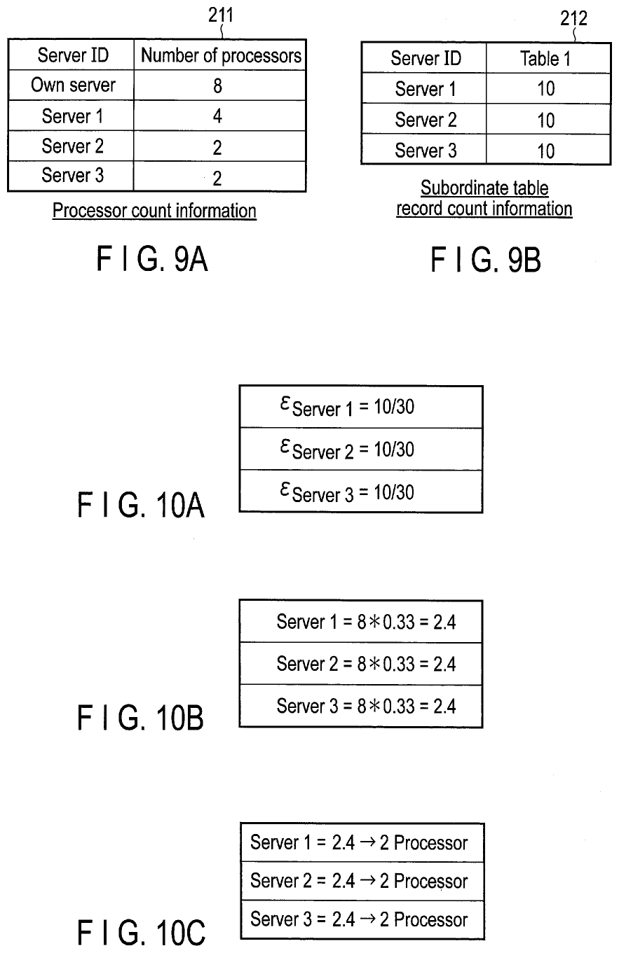

Next, an operation example of the query dividing module 114 in a case where all processing amounts of the subordinate servers (which hold the tables used for a query) are the same degree will be described with reference to FIGS. 9 and 10 in view of FIG. 6.

Hereinafter, it is assumed that there are the servers 1 to 3 which are the subordinate servers, and a query which uses the tables 1 dispersed in these subordinate servers is executed. Furthermore, as illustrated in FIG. 9A, the numbers of processors are assumed to be eight in the own server (host server), four in the server 1, two in the server 2 and two in the server 3. Furthermore, as illustrated in FIG. 9B, the numbers of holding records of the table 1 are each assumed to be 10 in each of the servers 1 to 3. That is, the number of holding records of the overall subordinate servers is 30.

In this case, too, the query dividing module 114 first calculates the ratio E of the numbers of the holding records of the servers 1 to 3 in the tables 1 as illustrated in FIG. 10A. When calculating the ratio s of the number of holding records in each subordinate server, the query dividing module 114 next temporarily calculates the number of the query executing modules 115 generated for each subordinate server as illustrated in FIG. 10B.

At this point of time, the query dividing module 114 calculates 2.4 as the number of the query executing modules 115 for all of the servers 1 to 3. The query dividing module 114 determines two (which is within the numbers of processors of the servers 1 to 3) obtained by rounding 2.4, as the number of the query executing modules 115 generated for these servers 1 to 3.

That is, as illustrated in FIG. 100, the query dividing module 114 determines to generate the six query executing modules 115 in total including the two query executing modules 115 for each of the servers 1 to 3. Hence, the six processors among the eight processors of the own server are used, and this query is executed in parallel by the six query executing modules 115. Furthermore, the query dividing module 114 divides a query into two, for the two query executing modules 115 generated for each subordinate server. Subsequently, the two queries divided by the dividing module 114 are transferred to each subordinate server from the query dividing module 114.

Thus, when the processing amounts of the subordinate servers are all the same degree, the query dividing module 114 operates to equally allocate the processors. In addition, while the number of processors of the own server is eight, the total generation number of the query executing modules 115 is six, and, while the number of processors of the server 1 is four, the number of the query executing modules 115 generated for the server 1 is six. Therefore, there is a room for allocating two more processors to processing related to the server 1, i.e., a room for generating the two more query executing modules 115. However, in this case, the processors of the own server are not allocated beyond the number calculated from the number of processors of the own server and the ratio of the number of holding records of the subordinate servers.

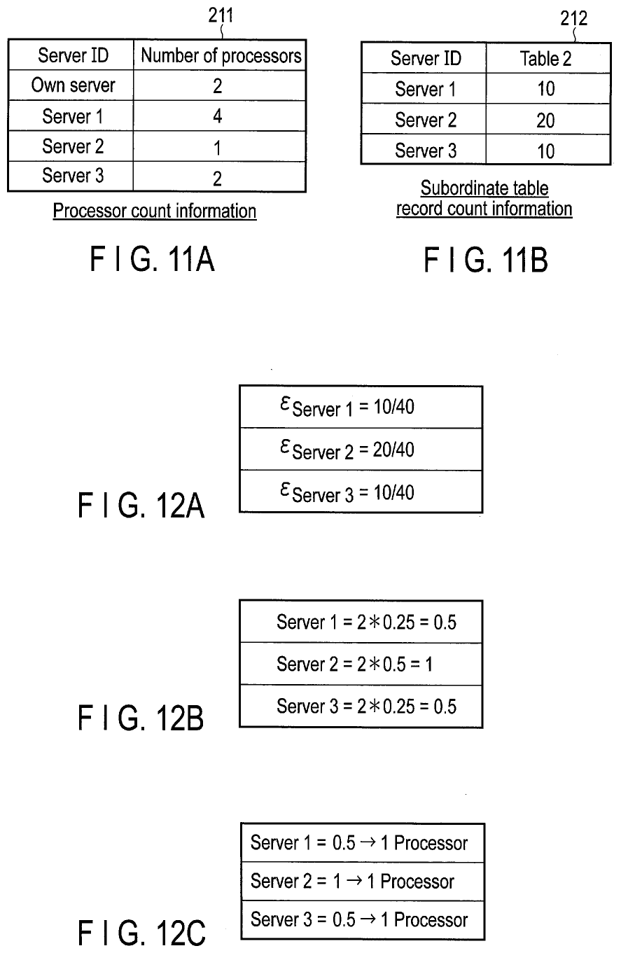

Next, an operation example of the query dividing module 114 in a case where the number of processors of the host server (own server) is smaller than the number of subordinate servers (which hold the table used for the query) will be described with reference to FIGS. 11 and 12 in view of FIG. 6.

Hereinafter, it is assumed that there are the servers 1 to 3 which are the subordinate servers, and a query which uses the tables 1 dispersed in these subordinate servers is executed. Furthermore, as illustrated in FIG. 11A, the numbers of processors are assumed to be two in the own server (host server), four in the server 1, one in the server 2 and two in the server 3. Furthermore, as illustrated in FIG. 11B, the numbers of holding records in the table 1 are assumed to be 10 in the server 1, 20 in the server 2 and 10 in the server 3. That is, the number of holding records of the overall subordinate servers is 40.

In this case, too, as illustrated in FIG. 12A, the query dividing module 114 first calculates the ratio e of the numbers of holding records of the servers 1 to 3 in the tables 1. When calculating the ratio e of the number of holding records in each subordinate server, the query dividing module 114 next temporarily calculates the number of the query executing modules 115 generated for each subordinate server as illustrated in FIG. 12B.

At this point of time, the query dividing module 114 calculates 0.5 as the number of the query executing modules 115 for the server 1, 1 as the number of the query executing modules 115 for the server 2 and 0.5 as the number of the query executing modules 115 for the server 3. In this regard, values less than one are calculated for the server 1 and the server 3, and therefore the query dividing module 114 determines one as the numbers of the query executing modules 115 generated for the server 1 and the server 3. One is calculated for the server 2, and therefore the query dividing module 114 determines one as the number of the query executing modules 115 generated for the server 2.

That is, as illustrated in FIG. 12C, the query dividing module 114 determines to generate the three query executing modules 115 in total including the one query executing module 115 for each of the servers 1 to 3. In this regard, the number of processors of the own server is two, and therefore the query executing modules 115 which exceed the number of processors of the own server are generated. Thus, when the number of processors of the host server (own server) is smaller than the number of subordinate servers (which hold tables related to a query), the query executing modules 115 which exceed the number of processors of the own server are generated. In this case, the two query executing modules 115 are allocated to the one processor of the two processors. The query dividing module 114 which generates the one query executing module 115 for each subordinate server distributes the query to each query executing module 115 without dividing the query.

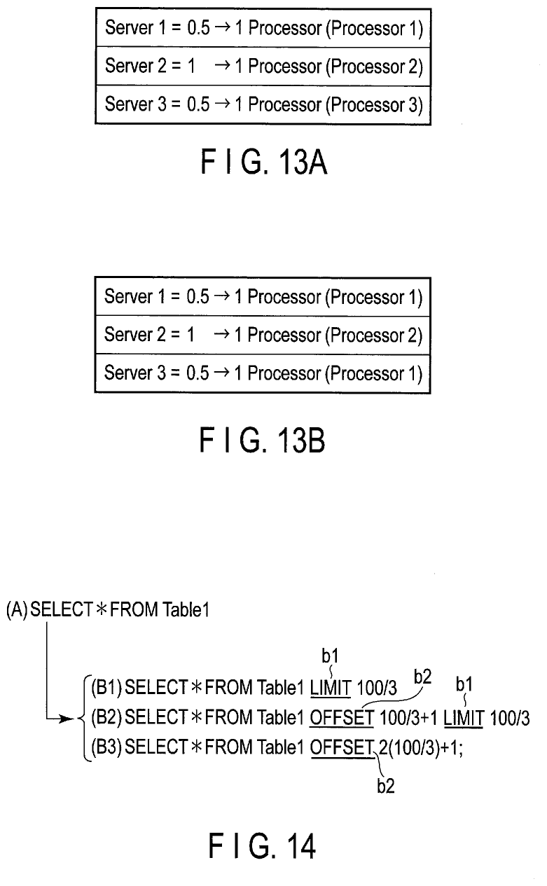

In addition, when there is a plurality of processing of subordinate servers whose generation number of the query executing modules 115 has been determined as one in order that a value calculated from the number of processors of the own server and the ratio of the number of holding records of the subordinate server is less than one, the query dividing module 114 may perform control to allocate a plurality of processing to one processor. When, for example, 0.5 is calculated from the number of processors of the own server and the ratio of the number of holding records of the subordinate server and therefore the generation number of the query executing modules 115 for the server 1 and the server 3 is determined as one as illustrated in FIG. 13A, the query executing modules 115 for the server 1 and the server 3 do not allocate to each of different processors and may be collectively allocated to one processor as illustrated in FIG. 13B.

More specifically, in order from the subordinate server of the smallest processing amount among the subordinate servers from which a value less than one has been calculated from the number of processors of the own server and the ratio of the number of holding records of the subordinate servers, the query executing modules 115 generated for the subordinate servers may be allocated to one processor until the calculated values may be added up and exceed one. FIG. 13A illustrates an example where the query executing module 115 generated for the server 1 and the query executing module 115 generated for the server 3 are allocated to the processor 1 and the processor 3 of the own server. On the other hand, FIG. 13B illustrates an example where the query executing module 115 generated for the server 1 and the query executing module 115 generated for the server 3 are collectively allocated to the processor 1.

Next, the query dividing method of the query dividing module 114 will be described with reference to FIG. 14.

The query dividing module 114 divides a query by using, for example, a LIMIT phrase (FIG. 14: b1) and an OFFSET phrase (FIG. 14: b2) which are standards of SQL (Structured Query Language).

In this case, the query dividing module 114 which has determined to generate the three query executing modules 115 for the subordinate server whose number of holding records in the tables 1 (Tables 1) used for the query is 100 is assumed to divide this query into three.

In this case, as illustrated in FIG. 14, the query dividing module 114 divides a query (A) “SELECT * FROM Table1” into three queries of (B1) “SELECT * FROM Table1 LIMIT 100/3”, (B2) “SELECT * FROM Table1 OFFSET 100/3+1 LIMIT 100/3” and (B3) “SELECT * FROM Table1 OFFSET 2(100/3)+1”. These queries are transferred from the query executing modules 115 of the own server to the query executing module 124 on the subordinate server side, and are executed in parallel.

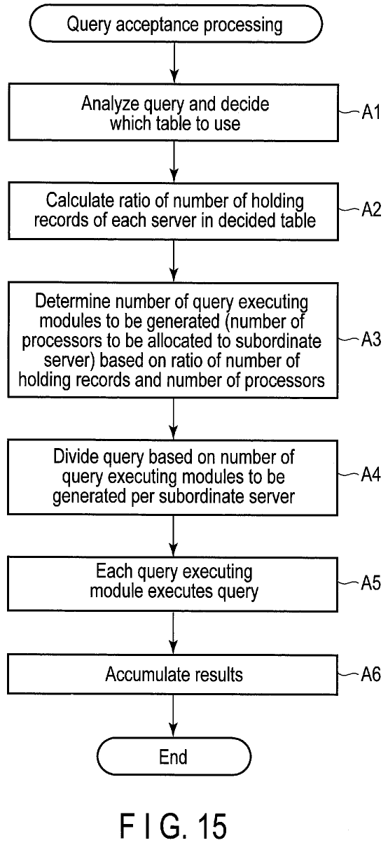

FIG. 15 is a flowchart illustrating a flow of query acceptance processing executed by the database management apparatus 1. In addition, a procedure of executing the query acceptance processing in the database management apparatus 1 will be described assuming that a query accepted by a user uses tables dispersed in subordinate servers.

The database management apparatus 1 first analyzes a query, and decides which table to use (step A1). Next, the database management apparatus 1 calculates a ratio of the number of holding records of each subordinate server in this table (step A2).

Subsequently, the database management apparatus 1 determines the number of the query executing modules 115 to generate, i.e., the number of processors (of the own server) to be allocated to each subordinate server based on the ratio of the number of the holding records and the number of processors (of the own server and each subordinate server) (step A3). Furthermore, the database management apparatus 1 divides the query based on the number of the query executing modules 115 to generate per subordinate server (step A4).

When determining the generation number of the query executing modules 115 and dividing the query, the database management apparatus 1 executes the query in each query executing module 115 (step A5). The database management apparatus 1 accumulates results obtained by the respective query executing modules 115 (step A6).

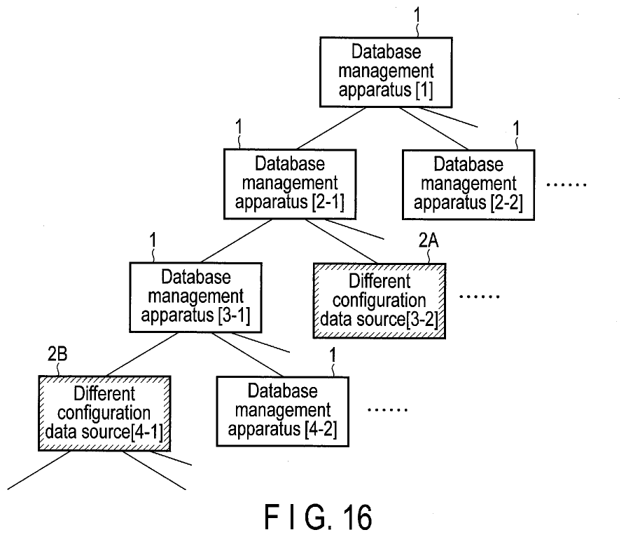

By the way, according to the above configuration, the host server and the subordinate servers employ the same configuration, own server information transmitted from the own server information transmitting module 123 on the subordinate server side to the host server is received by the subordinate server information obtaining module 112 on the host server side, and the subordinate server information management module 111 manages the own server information as subordinate server information. On the other hand, as illustrated in, for example, FIG. 16, there can be also a request that data sources 2A and 2B of existing and different configurations are implemented as one of a plurality of servers which configure a distributed database in a tree structure. The data sources 2A and 2B of different configurations are assumed to be data sources which do not include the own server information transmitting module 123, but also data sources which cannot execute SQL for accepting a query and hold tables of a CSV (Comma-Separated Value) format.

To meet this request, the database management apparatus 1 may further include a mechanism which absorbs a difference between the own server and the subordinate servers when there are subordinate servers of different configurations.

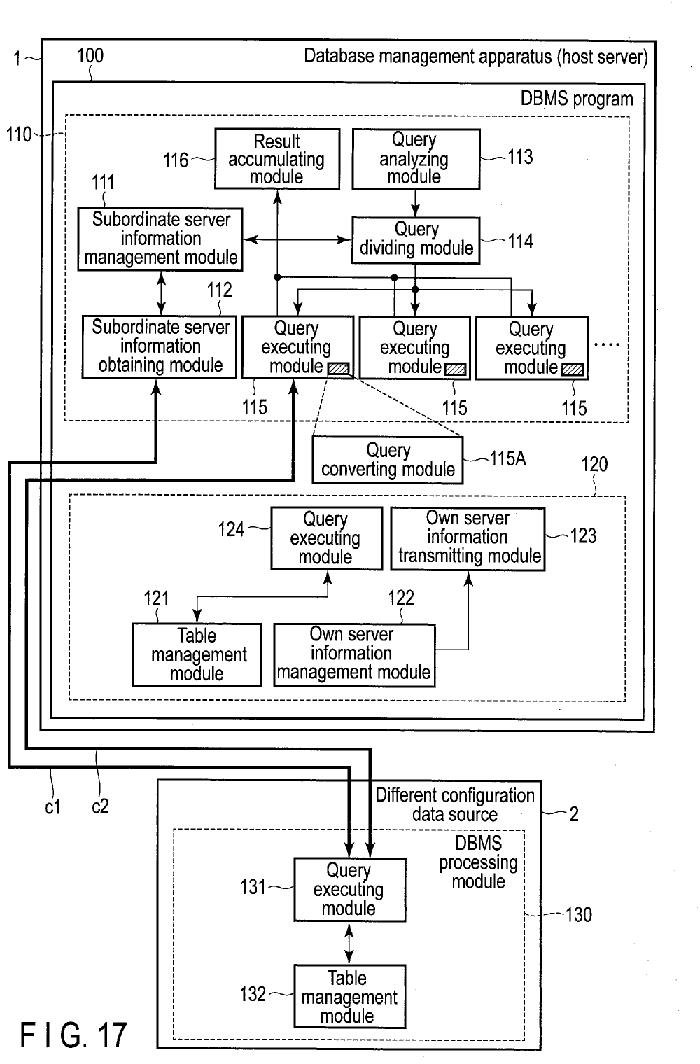

FIG. 17 is a view for explaining a first example of a mechanism which absorbs a difference between the subordinate servers when the subordinate servers are data sources of different configurations. In addition, hereinafter, the data sources 2A and 2B of the different configurations illustrated in FIG. 16 will be collectively referred to as different configuration data sources 2. Furthermore, hereinafter, the different configuration data source 2 in FIG. 17 is assumed to hold data in a CSV format which cannot execute SQL. The different configuration data source 2 includes a DBMS processing module 130 which includes at least a query executing module 131 which executes a query, and a table management module 132 which manages tables held in the CSV format.

In the first example, the subordinate server information obtaining module 112 first collects subordinate server information related to a subordinate server for this subordinate server which is the different configuration data source 2 from this subordinate server on a regular basis, for example (FIG. 17: c1). This subordinate server information is collected by, for example, transmitting a query for inquiring the number of holding records of a table held by this subordinate server. A result of the query transmitted from the subordinate server is transferred from the subordinate server information obtaining module 112 to the subordinate server information management module 111. The subordinate server information management module 111 updates the subordinate table record count information 212 based on this query result.

Furthermore, the query executing module 115 includes a query converting module 115A, and the query converting module 115A converts the query passed from the query dividing module 114 into an executable format of the subordinate server and transmits the converted query to the subordinate server (FIG. 17: c2). When a format before conversion and a format after conversion are turned out, this conversion can be realized by various existing methods.

For example, information indicating which subordinate server is the different configuration data source 2 and in which format the subordinate server which is the different configuration data source 2 holds a table may be given in advance to the database management apparatus 1 or may be actively obtained by the database management apparatus 1. When, for example, a subordinate server is newly connected, and when subordinate server information is not transmitted from the subordinate server to the own server after a certain period, this subordinate server may be decided as the different configuration data source 2, and a query for inquiring a holding table and the number of holding records of the table may be transmitted.

Consequently, the database management apparatus 1 can absorb the difference between the own server and the subordinate servers. In addition, when subordinate server information is collected on a regular basis, an error may occur in the number of holding records during executing a query, for example. However, the query is divided as illustrated in FIG. 14, and therefore a load may vary between the divided queries, but the records do not leak.

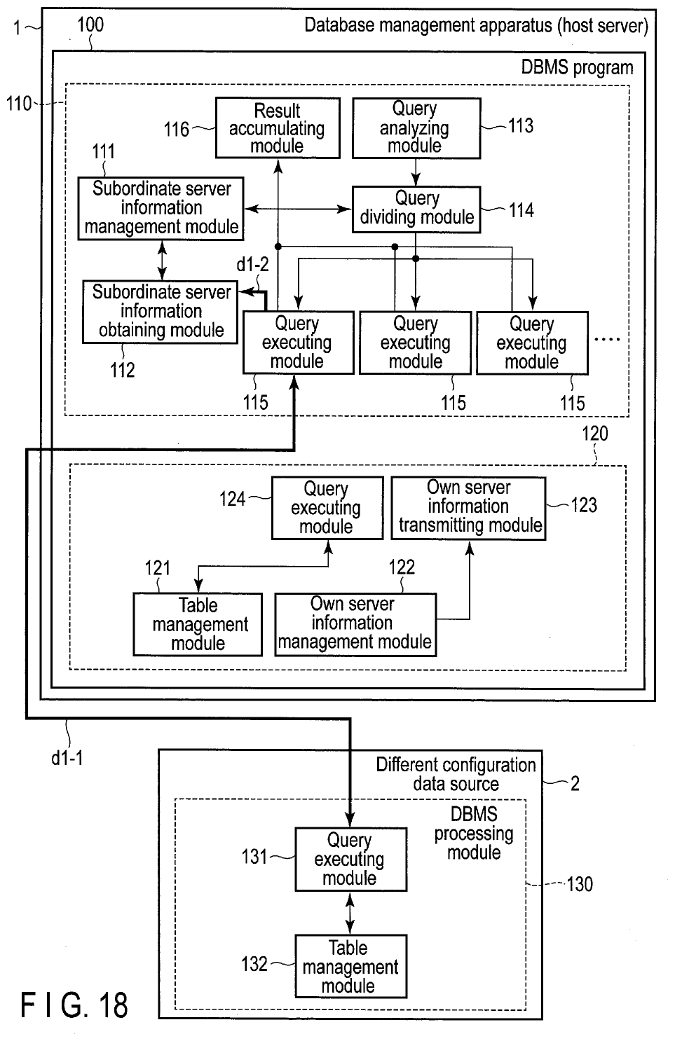

Furthermore, FIG. 18 is a view for explaining a second example of a mechanism which absorbs a difference between subordinate servers when the subordinate servers are data sources of different configurations. In this case, the same matter as the above-described first example is assumed for the different configuration data source 2. Furthermore, the query executing module 115 includes the query converting module 115A.

In this second example, instead of collecting subordinate server information on a regular basis, the query executing module 115 collects the subordinate server information at a timing (FIG. 18: d1-1) at which the query executing module 115 transmits a query to the subordinate server. When receiving a notification from the query executing module 115 which transmits the query to the subordinate server which is the different configuration data source 2 (FIG. 18: d1-2), the subordinate server information obtaining module 112 transmits to the subordinate server a query for inquiring the number of holding records of the table held by this subordinate server, too. The subordinate server information obtaining module 112 accepts a result of the query requested by the subordinate server information obtaining module 112 from the query executing module 115 to transfer the result to the subordinate server information management module 111.

In the second example, the subordinate server information may be collected every time the query executing module 115 transmits the query to the subordinate server, or may be collected when the query executing module 115 transmits the query to the subordinate server after a certain period or more passes since previous collection.

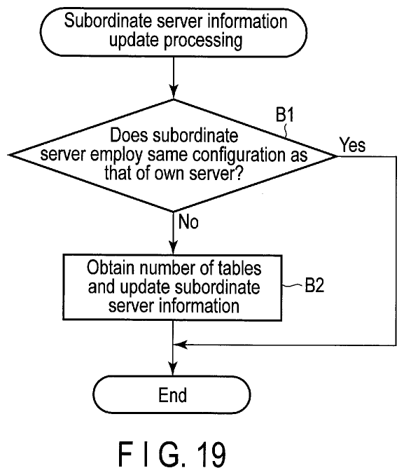

FIG. 19 is a flowchart illustrating a flow of subordinate server information update processing executed by the database management apparatus 1.

The database management apparatus 1 checks whether or not the subordinate server employs the same configuration as that of the own server (host server) (step B1). In a case of the same configuration (step B1: YES), the subordinate server side transmits subordinate server information as own server information. Consequently, the database management apparatus 1 does not actively collect the subordinate server information from the subordinate server.

On the other hand, in a case of the different configuration (step B1: NO), the database management apparatus 1 obtains the number of tables from the subordinate server at a predetermined timing, and updates the subordinate server information related to this subordinate server (step B2).

As described above, the database management apparatus 1 according to the present embodiment realizes efficient resource allocation by taking into account the number of holding records of the table in each subordinate server, the number of processors of the host server (own server), and the number of processors of each subordinate server.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A database management apparatus capable of operating as one of a plurality of servers constituting a distributed database in a tree structure, the database management apparatus comprising:
a processor configured to:
manage server information of an own server and a subordinate server;
analyze an input query, and decide a table used for the query;
determine a generation number of query executing modules configured to execute the query, based on the server information of the own server and the subordinate server, and divide the query according to the generation number if a plurality of query executing modules is generated for a subordinate server; and
accumulate a result of the query executed by the query executing modules of the determined generation number.

2. The database management apparatus according to claim 1, wherein
the processor is configured to:
manage, as the server information, a number of processors of the own server and the subordinate server, and a number of holding records of each subordinate server in tables distributed in a plurality of subordinate servers, and
determine the generation number of the query executing modules based on the number of processors of the own server, the number of processors of a subordinate server configured to hold the table used for the query, and a value of a ratio of the number of holding records of each subordinate server with respect to a total number of records.

3. The database management apparatus according to claim 2, wherein the processor is configured to determine a number of the query executing modules generated for each subordinate server based on a value obtained by multiplying the number of processors of the own server with the value of the ratio of the number of holding records of each subordinate server with respect to the total number of records.

4. The database management apparatus according to claim 3, wherein the processor is configured to determine the number of processors of one of the subordinate servers as the number of the query executing modules generated for the one of the subordinate servers when the value of the one of the subordinate servers exceeds a number of processors of the subordinate server, the value being obtained by multiplying the number of processors of the own server with the value of the ratio of the number of holding records of the one of the subordinate servers with respect to the total number of records.

5. The database management apparatus according to claim 3, wherein the processor is configured to determine one as the number of the query executing modules generated for one of the subordinate servers when the value of the one of the subordinate servers is less than one, the value being obtained by multiplying the number of processors of the own server with the value of the ratio of the number of holding records of the one of the subordinate servers with respect to the total number of records.

6. The database management apparatus according to claim 5, wherein the processor is configured to allocate, when there is a plurality of the query executing modules generated after the value less than one is obtained, two or more of the query executing modules to a processor of the own server.

7. The database management apparatus according to claim 1, wherein the processor is configured to:
transmit, when a number of holding records of a table held in the own server is updated, the updated server information of the own server to a host server; and
obtain the server information of the subordinate server, and
manage the obtained server information of the subordinate server.

8. The database management apparatus according to claim 7, wherein the processor is configured to receive, when the subordinate server employs a configuration similar to that of the own server to transmit the updated server information to the host server, the server information of the subordinate server from the subordinate server.

9. The database management apparatus according to claim 7, wherein
the processor is configured to collect, when the subordinate server employs a configuration different from that of the own server, the server information of the subordinate server from the subordinate server on a regular basis, and
the configuration different from that of the own server is a configuration not to transmit the updated server information to the host server.

10. The database management apparatus according to claim 7, wherein
the processor is configured to causes, when the subordinate server employs a configuration different from that of the own server, the query executing module to transmit a query for collecting the server information to the subordinate server at a timing when the query executing module transmits the query to the subordinate server, and
the configuration different from that of the own server is a configuration not to transmit the updated server information to the host server.

11. A query dividing method of a database management apparatus capable of operating as one of a plurality of servers constituting a distributed database in a tree structure, the query dividing method comprising:
managing server information of an own server and a subordinate server;
analyzing an input query, and deciding a table used for the query;
determining a parallel number for executing the query in parallel, based on the server information of the own server and the subordinate server, and dividing the query according to the parallel number when a plurality of queries is executed in parallel for a subordinate server; and
collecting a result of the query executed at the determined parallel number.
